(19) United States
(12) Patent Application Publication
(10) Pub. No.: US 2017/0095734 A1
(43) Pub. Date: Apr. 6, 2017

(54) DUAL SCREEN GAME CONTROLLER WITH CAMERA

(71) Applicant: Jeffrey John O'Donnell, SR., Pelzer, SC (US)

(72) Inventor: Jeffrey John O'Donnell, SR., Pelzer, SC (US)

(21) Appl. No.: 14/875,688

(22) Filed: Oct. 5, 2015

(51) Int. Cl. A63F 13/26; A63F 13/24; A63F 13/323; H04N 5/225

(52) U.S. Cl. CPC A63F 13/26; H04N 5/225; A63F 13/24; A63F 13/323

(57) ABSTRACT

Implementations of a dual screen game controller are provided. In some implementations, the game controller includes a camera. In some implementations, a first screen is configured to display game selections and the second screen is configured to display images from a second game controller's camera.

### CROSS REFERENCE TO RELATED APPLICATION

This is a continuation-in-part of U.S. patent application Ser. No. 29/497,062, which was filed on Jul. 21, 2014, and is incorporated herein by reference in its entirety.

### TECHNICAL FIELD

This disclosure relates to implementations of a dual screen game controller.

### BACKGROUND

In existing on-line multi-player gaming environments, all player selections, options, and next game play are displayed to the player's opponent on a display screen.

### BRIEF DESCRIPTION OF THE DRAWINGS

FIG. 1 illustrates an example computing device for using an example dual screen game controller according to an implementation of the present disclosure.

FIG. 2 illustrates an example online gaming environment for using an example dual screen game controller according to an implementation of the present disclosure.

FIG. 3 illustrates an example remote gaming environment for using an example dual screen game controller according to an implementation of the present disclosure.

FIG. 4 illustrates an example dual screen game controller according to an implementation of the present disclosure.

### DETAILED DESCRIPTION

Implementations of a dual screen game controller are provided.

Implementations of the present disclosure use a dual screen game controller to play a video game played on a separate gaming device (e.g., a game console, a PC). Gaming devices may include game consoles and personal computers. Game controllers may include the Xbox 360 controller, Xbox One controller, Wii Remote, Wii U Game controller, and Sony's DualShock3 or any other game controller. In some implementations, a game controller may include multiple input controls. In some implementations a game controller may include a directional pad, buttons, triggers, and/or one or more sticks.

In some implementations, the functional control output generated by the game controller may be able to interact with the gaming device.

In some implementations, the game controller may communicate commands wireless or wired to the gaming device. In some implementations, the game controller may communicate with the gaming device via a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. In some implementations, the game controller may communicate via infrared.

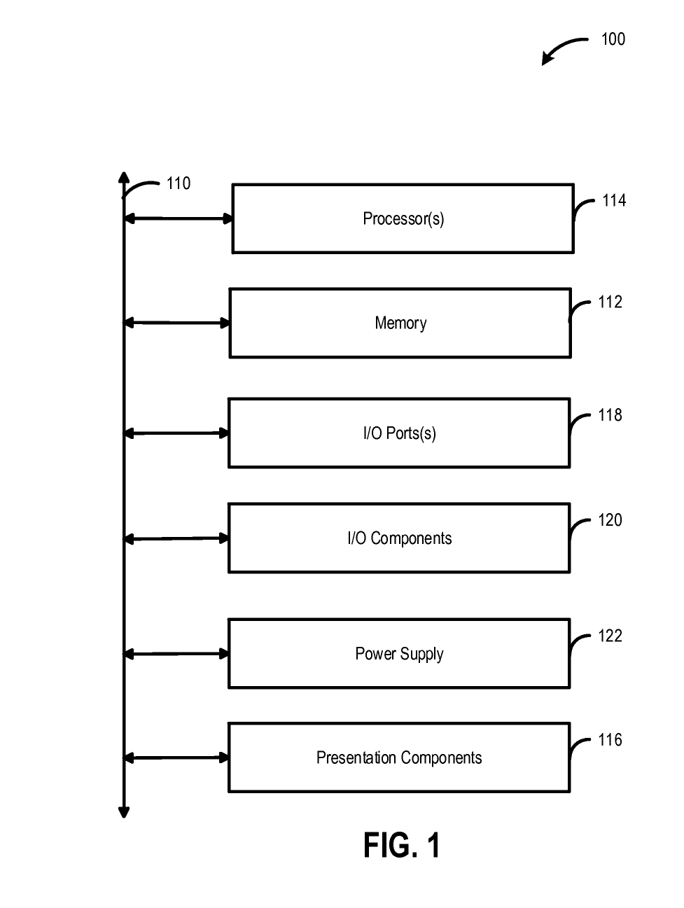

FIG. 1 illustrates an example computing device 100 for using an example dual screen game controller according to an implementation of the present disclosure. In some implementations, the computing device 100 may include a bus 110 that directly or indirectly couples a memory 112, one or more processors 114, one or more presentation components 116, input/output (I/O) ports 118, I/O components 120, and a power supply 122.

Although this disclosure describes and illustrates a particular bus, this disclosure contemplates any suitable bus or interconnect. Although this disclosure describes and illustrates a particular computer system having a particular number of particular components in a particular arrangement, this disclosure contemplates any suitable computer system having any suitable number of any suitable components in any suitable arrangement.

Memory 112 includes computer-storage media in the form of volatile and/or nonvolatile memory. The memory 112 may be removable, nonremovable, or a combination thereof. In some implementations, memory includes solid-state memory, hard drives, optical-disc drives, etc.

Computing device 100 includes one or more processors 114 that read data from various entities such as bus 110, memory 112 or I/O components 120.

Presentation component(s) 116 present data indications to a user or other device. In some implementations presentation components 116 include a display device, speaker, printing component, vibrating component, etc.

I/O ports 118 allow computing device 100 to be logically coupled to other devices including I/O components 120, some of which may be built in. In some implementations, I/O components 120 include a microphone, joystick, game controller, satellite dish, scanner, printer, wireless device, etc.

Implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules or other data in a modulated data signal such as a carrier wave or other transport mechanism and includes any information delivery media. In some implementations, a modulated data signal may be a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

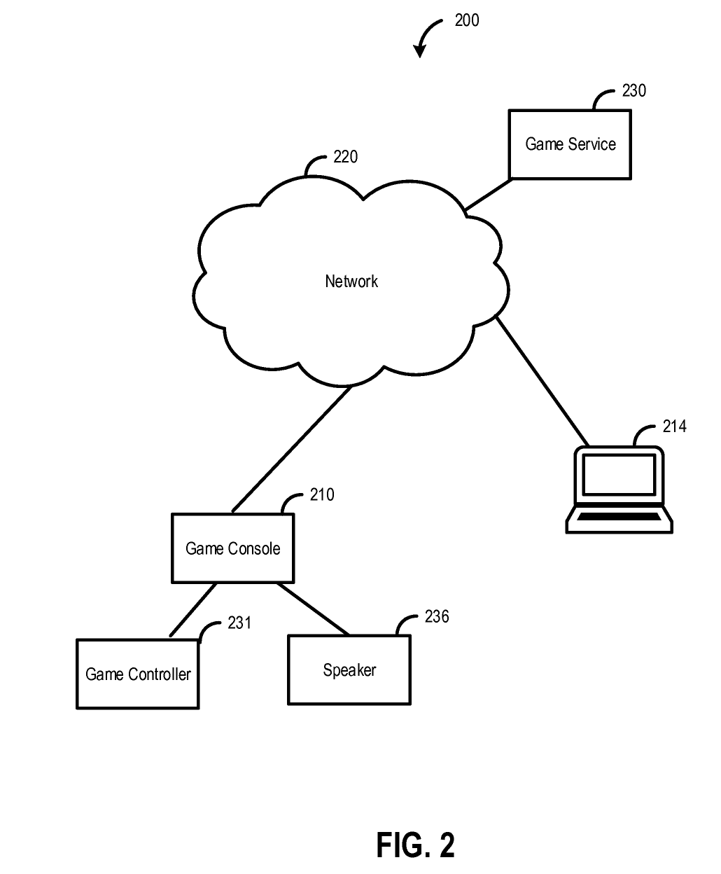

FIG. 2 illustrates an example online gaming environment 200 for using an example dual screen game controller according to an implementation of the present disclosure.

In some implementations, the online gaming environment 200 comprises various game clients connected through a network 220 to a game service 230. In some implementations, game clients include a game console 210 and a personal computer 214. Use of other game clients, such as smart phones, are also possible.

The game console 210 may have one or more game controllers communicatively coupled to it.

In some implementations network 220 may be a wide area network, such as the Internet. In some implementations, network 220 may be an intranet, an extranet, a virtual private network (VPN), a local area network (LAN), a wireless LAN (WLAN), a wide area network (WAN), a metropolitan area network (MAN), a portion of the Internet, or another network 220 or a combination of two or more such networks 410. The present disclosure contemplates any suitable network 220.

In some implementations, the controllers associated with game console 210 may include a game controller 231 and a headset 236. A game console may be associated with control devices that generate both a rich input and a basic input. Individual controllers may be capable of generating different kinds of inputs and a single controller may generate both a rich input and an basic input.

The game controller 231 may be capable of generating basic control signals, such as those generated by button selections and joystick movement. Movement data such as that generated by accelerometers and gyros within the game controller 231 may be examples of rich sensory data. In some implementations, the movement data is not considered a rich sensory data.

The headset 236 may captures audio input from a player and the player's surroundings and may also act as an output device if it is coupled with a headphone or other speaker.

Various combinations of components shown in FIG. 2 may execute code needed to play a video game. For example, game code may be executed by game console 210 and controlled by game controller 231. In some implementations, game code may be executed by PC 214 and controlled by game controller 231. In some implementations, game code may be executed by game service 230 producing a rendered video game image that is displayed on PC 214, game controller 231, or a television or other display device (e.g., tablet or other handheld device) (not shown). Other combinations can be possible including split render and execution scenarios where part of the video game code is executed by different devices and combined into a single video game image.

Game service 230 may comprise multiple computing devices communicatively coupled to each other. In some implementations, the game service 230 may be implemented using one or more data centers. The data centers may be spread out across various geographic regions including cities throughout the world. In this scenario, the game clients may connect to the closest data centers. Implementations of the present disclosure are not limited to this setup.

The game service 230 may allow the game to be executed within the computing devices provided by the game service 230. A communication session between the game service and game clients carries input traffic to the game service 230 and can return a rendered game image and/or other game output.

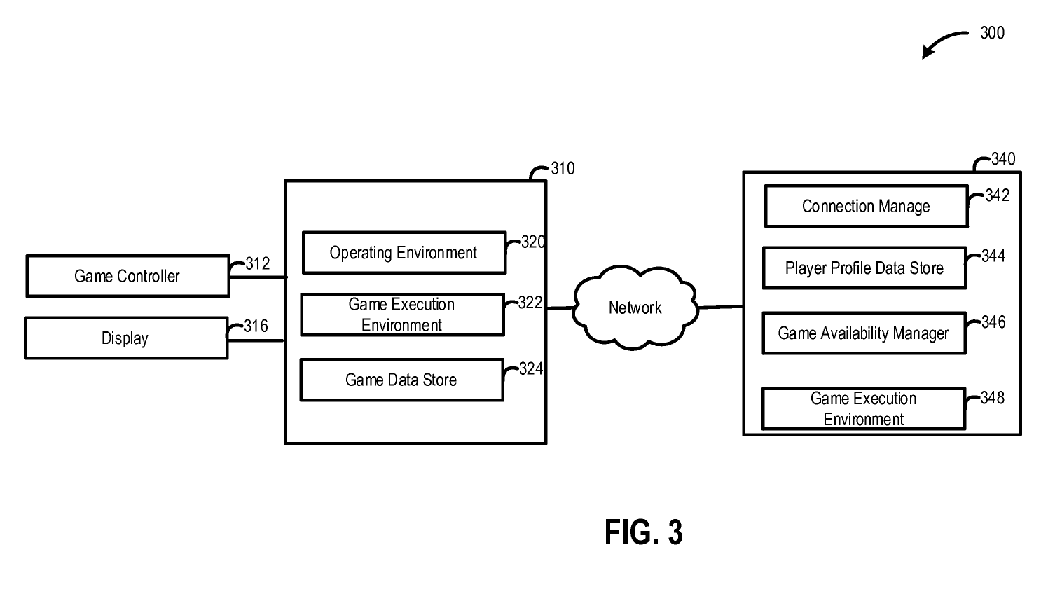

FIG. 3 illustrates an example remote gaming environment 300 for using an example dual screen game controller according to an implementation of the present disclosure.

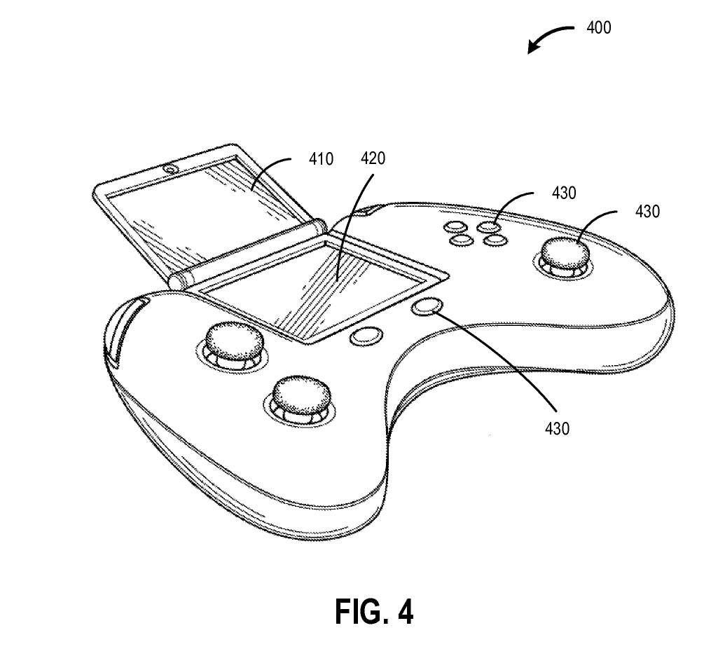

The remote gaming environment 300 includes a gaming device 310 communicatively coupled to a game server 340 through a network 330. In some implementations, the network 330 may be the Internet. The gaming device 310 may be connected to a game controller 312 (as described with reference to FIG. 4) and a remote display 316.

Other game input devices may be used with the gaming device 310, including keyboards, a mouse, a touch pad, a touch screen, a microphone for receiving voice commands, a depth camera, a video camera, and a trackball. Implementations of the present disclosure are not limited to these input devices.

The display 316 may be capable of displaying video game content. For example, the display 316 may be a television or computer screen.

In some implementations, the gaming device 310 is a computing device that is able to execute video games. In some implementations, the gaming device 310 may be laptop computer or a game console. In some implementations, the gaming device 310 may include an operating environment 320, a game execution environment 322, and a game data store 324. Other components of the gaming device 310 are not shown for the sake of simplicity.

The operating environment 320 may be provided by an operating system that manages the hardware and provides services to applications running on the gaming device 310. The operating environment may allocate client resources to different applications as part of game and communication functions.

The game data store 324 may store downloaded games, game samples, and/or partially downloaded games. Games may be downloaded in playable blocks. In some implementations, to play a game, the game may need to be loaded from the game data store 324 into active memory associated with the game execution environment 322. The game data store 324 may also store player progress files.

In some implementations, the game execution environment 322 may comprise the gaming resources on the device 310 required to execute instances of a game. The game execution environment 322 may comprises active memory along with computing and video processing resources. The game execution environment 322 may receive gaming controls and cause the game to be manipulated and progressed according to game programming. In one aspect, the game execution environment 322 outputs a rendered video stream that is communicated to the display 316.

In some implementations, the game server 340 may comprise a connection manager 342, a player profile data store 344, a game availability manager 346, and a game execution environment 348. Though depicted as a single box, the game server 340 could be a data center that comprises numerous machines, or even several data centers. Several of the servers could act as clients for a central server that coordinates the game experience.

The connection manager 342 builds a connection between the gaming device 310 and the service 340. The connection manager 342 may also provide various authentication mechanisms to make sure that the user is authorized to access the game service provided by the service 340. The connection manager may provide security, encryption, and authentication information to servers and virtual machines as they are added to a game session.

The player profile data store 344 may work in conjunction with the connection manager 342 to build and store player information. Part of the player profile may comprise demographic and financial information such as a player's name, address and credit card information or other mechanism for paying for or purchasing games and experiences provided by the game service.

In addition, the player profile data store 344 may store a player's progress within an individual game. A player's score, achievements, and progress through game levels may be stored. Further, the player profile data store 344 may store information about individual player preferences such as language preferences. The player may access the game level information from multiple clients. For example, the player's progress could be accessed from a friend's game console or on the player's mobile device.

The player profile data store 344 may also store a usage history for the individual player. A player's history of purchasing games, sampling games, or playing games through a game service that does not require the purchase of the games may be stored.

The game availability manager 346 analyzes the usage data to determine, among other things, how many standby instances of a particular game title should be available. In general, games with a high demand will have more standby instances of a game available. Loading a game into active memory to create a standby instance may take a minute or two; thus, games with high churn in and out may also require more standby instances of games to be available. The time it takes to create a standby instance of a particular game title also should be considered. Games that load comparatively quickly may require less standby instances because additional game instances can be generated more quickly as demand changes. In other words, games with a slower load time may require more available standby games.

The game execution environment 348 comprises the gaming resources required to execute instances of a game. The game execution environment 348 comprises active memory along with computing and video processing. The game execution environment 348 receives gaming controls, such as reduced controller input, through an I/O channel and causes the game to be manipulated and progressed according to its programming. In one aspect, the game execution environment 348 outputs a rendered video stream that is communicated to the game client. In other aspects, the game execution environment 348 outputs game geometry, or other representations, which may be combined with local objects on the gaming client to render the gaming video.

FIG. 4 illustrates an example dual screen game controller 400 according to an implementation of the present disclosure.

In some implementations, the game controller 400 comprises a first display screen 410, a second display screen 410, and a plurality of controls 430. In some implementations, the plurality of controls 430 may be any control on a game controller.

In some implementations, the first display screen 410 and second display screen 420 may be hinged such that the first screen may fold on top of the second screen.

In some implementations, the game code may be configured such that video game images comprising a player's strategic game play such as a player's selection (e.g., play selection or any other selection), options, next game play move, or court formation are rendered on at least one of the screens of the game controller 400 used by the player. In some implementations, the player's strategic game play is rendered only on the game controller 400 used by the player. In some implementations, the player's strategic game play is rendered on the game controllers 400 used by the player and the player's teammates.

In some implementations, game play is rendered on a display separate from the controller and a player's strategic game play selections and/or options are rendered on the game controller.

In this way, a player's game selection (e.g., play selections, court formation, batting stance) are not revealed to an opponent. For example, in a warfare game, a player's opponent will not see the player's weapon selection or “mini-map”.

In some implementations, the video displays may show two views of a game in progress. For example, in some implementations, the video display may show offensive games plays on one display and defensive game plays on a second display.

In some implementations, for a baseball online video game, a first screen may be used to display and select pitching (e.g., fast ball, change up, curve, slider) or batting (swing away, contact, bunt) options and the second screen may be used to display a batter's box and select a location of pitch.

In some implementations, at least one screen may be used to display player statistics or other background information about a player or coach. In some implementations, at least one screen may be used to display a team roster.

In some implementations, a first screen can be used to display and select a play selection and a second screen can be used to display and select ball placement or execution.

In some implementations, at last one screen may be used for calling of offense and/or defense plays (fake punts, field goals, etc.).

In some implementations, one or more of the video displays may be a touch screen and a player may make a selection from the touch screen.

In some implementations, when a game controller control is activated (e.g., via touch screen or by the one or more controls), the game controller communicates a functional instruction to the gaming device. The gaming device interprets the functional instruction. This instruction may be fed to a video game title and the game manipulated according to the consequence of activating the control.

In some implementations, at least one of the screens may include a camera for transmitting a player's image to an opponent. In some implementations, one of the screens may display an opponent's image or an image transmitted by an opponent's game controller.

Reference throughout this specification to “an embodiment” or “implementation” or words of similar import means that a particular described feature, structure, or characteristic is included in at least one embodiment of the present invention. Thus, the phrase “in some implementations” or a phrase of similar import in various places throughout this specification does not necessarily refer to the same embodiment.

Many modifications and other embodiments of the inventions set forth herein will come to mind to one skilled in the art to which these inventions pertain having the benefit of the teachings presented in the foregoing descriptions and the associated drawings.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

While operations are depicted in the drawings in a particular order, this should not be understood as requiring that such operations be performed in the particular order shown or in sequential order, or that all illustrated operations be performed, to achieve desirable results.

1. A gaming environment comprising:
at least a first gaming device and a second gaming device; and
wherein the first gaming device is connected to a first game controller having a first display screen, a second display screen, and a camera;
wherein the second gaming device is connected to a second game controller having a first display screen, a second display screen, and a camera;
wherein the first gaming device and second gaming device are coupled to one or more game servers through a network;
wherein the first gaming device and the second gaming device are configured to execute a game;
wherein the first gaming device is configured to communicate a video stream to the first game controller to display game selections on a first display screen and display images from the second game controller camera on a second display screen; and
wherein the second gaming device is configured to communicate a video stream to the second game controller to display game selections on a first second display screen and display images from the first game controller camera on a second display screen.

2. A gaming environment of claim 1 further wherein the first screen and the second screen of each of the first and second game controller are hinged.

3. A gaming environment of claim 1 wherein the first gaming device is connected to a separate third display and the second gaming device is connected to a separate fourth display,
wherein the first gaming device is configured to communicate a video stream to the third display to display game play that does not include game selections displayed on the second controller, and
wherein the second gaming device is configured to communicate a video stream to the fourth display to display game play that does not include game selections displayed on the first game controller.
